(19) United States
(12) Patent Application Publication
(10) Pub. No.: US 2017/0123083 A1
(43) Pub. Date: May 4, 2017

(54) Tomography System and Method for Large-volume Recordings

(71) Applicant: Robert Divoky, Forchheim (DE)

(72) Inventor: Robert Divoky, Forchheim (DE)

(21) Appl. No.: 15/340,927

(22) Filed: Nov. 1, 2016

(30) Foreign Application Priority Data
Nov. 2, 2015 (DE) 102015221418.4

(51) Int. Cl. G01T 1/29; G01N 23/04; G01N 21/64

(52) U.S. Cl. CPC G01T 1/2985; G01T 1/2964; G01N 21/6456; G01N 23/046; G01N 2201/1035; G01N 2223/419

(57) ABSTRACT

A tomography system includes a first radiation source and a first detector that is assigned to the first radiation source. The tomography system also includes a second radiation source and a second detector that is assigned to the second radiation source. The tomography system is prepared to perform a scan. In a first plane of rotation, the first detector is guided along a first circular segment-shaped path. In a second plane of rotation, the second detector is guided in synchrony along a second circular segment-shaped path. The tomography system is configured to obtain a first data record with the first detector and a second data record with the second detector. The first plane of rotation and the second plane of rotation are arranged at a distance from one another.

This application claims the benefit of DE 10 2015 221 418.4, filed on Nov. 2, 2016, which is hereby incorporated by reference in its entirety.

### BACKGROUND

The present embodiments relate to a tomography system and a method for operating a tomography system.

Each of the two data records is typically three- or four-dimensional. A three-dimensional data record may be a data record of a volume scan, from which a complete volume image may be reconstructed. A four-dimensional data record may be a series of at least two three-dimensional data records, from which at least two volume images that follow one another in time may be reconstructed. A first of the volume images shows, for example, an initial distribution phase, and a second of the volume images shows, for example, a delivery phase. The tomography system may be, for example, an x-ray tomography system or a fluorescence tomography system.

Typically both paths have an identical shape (e.g., with a mutual offset about a circumferential angle difference). A distance between the first radiation source and the first detector may remain constant, while the first detector is guided along the circular segment-shaped first path about the orbital axis. This also applies to a distance between the second radiation source and the second detector. The distance between the second radiation source and the second detector may be just as large as a distance between the first radiation source and the first detector. It may also be advantageous if the two distances are different sizes (e.g., in order to balance out a difference in detector sizes). The first radiation source and the first detector may be fastened on a shared movable support (e.g., on the same first C-arm or on different movable supports (on one robot arm in each instance)). The same also applies to the second radiation source and the second detector. An image amplifier may optionally be connected to the first detector. This also applies to the second radiation source and the second detector. One option that is independent hereof provides that the first detector includes an image amplifier, and/or the second detector includes an image amplifier.

Ever greater demands are being placed on the performance of medical devices particularly in diagnostics and therapy. The objective of avoiding health hazards and injury to persons as a result of an incorrect diagnosis or treatment is thus pursued, for example.

DE 10 2006 040 934 A1 describes a method for displaying arteries and/or veins of a vascular system using a C-arm biplanar system, which includes two C-arms. During a filling cycle, each C-arm will record a sequence of x-ray images from different projection angles. The x-ray images of the filling cycle of the first C-arm and the second C-arm from an arterial phase are combined to form a first data record. The reconstruction to form a three-dimensional data record may take place before combining the data of the x-ray images of the two C-arms or on the data record of the extracted, arterial vascular system.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a tomography system and a method for operating a tomography system, with which a larger volume 3D recording (e.g., of a vertebra, an aorta, or another blood vessel) may be performed in a single work cycle (e.g., after just one single contrast agent injection) than with the known tomography system, are provided.

A tomography system includes a first radiation source and a first detector that is assigned to the first radiation source. The tomography system also includes a second radiation source and a second detector that is assigned to the second radiation source. The tomography system is configured to perform a scan, where in a first plane of rotation, the first detector is guided along a first circular segment-shaped path, while in a second plane of rotation, the second detector is guided in synchrony along a second circular segment-shaped path. The tomography system is configured to obtain a first data record with the first detector and a second data record with the second detector. The two planes of rotation are arranged at a distance from one another.

In one embodiment, the method for operating a tomography system includes performing a scan, where in a first plane of rotation, a first detector is guided along a first circular segment-shaped path, while in a second plane of rotation, a second detector is guided in synchrony along a second circular segment-shaped path. A first data record is obtained with the first detector, and a second data record is obtained with the second detector. The two planes of rotation are arranged at a distance from one another.

In one or more of the present embodiments, the planes of rotation of the two detectors are at a distance from one another. A maximum spatial expansion of the recording ability of the tomography system is enlarged in the orbital axis direction. The fact that the planes of rotation of the two detectors are at a distance from one another provides that a first point of intersection of a first orbital axis of the first plane of rotation with the first plane of rotation is at a distance from a second point of intersection of a second orbital axis of the second plane of rotation with the second plane of rotation. Typically, the two orbital axes are arranged identically or run at least parallel to one another. Together, the two data records represent a comprehensive data record, from which a comprehensive tomography image may be generated using one of the known reconstruction methods (e.g., using a filtered back projection method according to Feldkamp, Davis, Kress).

One embodiment of the tomography system provides that the tomography system is configured to generate a comprehensive two-, three- or four-dimensional data record from both data records prior to an image reconstruction. The data of the second data record may be compared with the data of the first data record in the adjoining region or in the overlapping region and may be matched using a spatial and/or temporal mapping to the data of the first data record, so that a comprehensive data record is created. The data of the comprehensive data record in the overlapping region represents an interference-free transition between the first data record and the second data record. The mapping may include, for example, a spatial and/or temporal displacement and/or a rotation about one or a number of Euler angles (e.g., yaw angle, pitch angle, roll angle) and/or a lengthening or compressing and/or any other concordant mapping. Suitable methods for such a manual or automatic adjustment between two data records are not described here, since such methods are known to the person skilled in the art under the term “registration”.

A further embodiment of the tomography system provides that the tomography system is prepared to generate a first two-, three- or four-dimensional image from the first data record using a first image reconstruction, a second two-, three- or four-dimensional image from the second data record using a second image reconstruction, and a comprehensive two-, three- or four-dimensional image from the first image and the second image. The data of the second reconstructed image may be compared with the data of the first reconstructed image in the adjoining region or in the overlapping region and may be matched to the data of the first image using a spatial and/or temporal mapping, so that a comprehensive image is created. The data of the comprehensive image in the overlapping region represents an interference-free transition between the first data record and the second data record. The mapping may also include, for example, a spatial and/or temporal displacement and/or a rotation about one or a number of Euler angles (e.g., yaw angle, pitch angle, roll angle) and/or a lengthening or compressing and/or any other compliant mapping. Suitable methods for a manual or automatic adjustment between two images that are known to the person skilled in the art under the term “registration” may also be used.

In one embodiment, the two planes of rotation minus an overlapping width are distanced by less than half the width of the first detector plus half the width of the second detector. The overlapping width amounts, for example, to between 10% and 20% of half the width of the first detector in the orbital axis direction or half the width of the second detector in the orbital axis direction. Using a spatial overlapping of the recording regions that may be detected by the detectors, a spatial gap in the comprehensive overall recording may also be avoided by taking tolerances into account. A structure of the object to be examined may be used to compare the data of the second data record with the data of the first data record in the overlapping volume and, using a spatial and/or temporal mapping, to match the same to the data of the first data record such that a comprehensive data record is created. The data of the comprehensive data record in the overlapping volume represents an interference-free transition between the first recording region and the second recording region.

Typically, the second circular segment-shaped path is arranged concentric to the first circular segment-shaped path. Irrespective of this, a radius of the first circular segment-shaped path may be the same size as a radius of the second circular segment-shaped path. The prerequisites for both are that the external dimensions of the reconstructable volume of the comprehensive data record are continuous.

In one embodiment, a starting position of the second circular segment-shaped path is arranged offset by a circumferential angle difference with respect to a starting position of the first circular segment-shaped path in the direction of rotation. In this way, the two detectors may run through paths that have an identical diameter and are concentric to one another.

Known advantages are provided if the tomography system is prepared to perform a short scan with the first detector and/or with the second detector. With a short scan, an angular or orbital rotation of the respective pair of radiation source and detector by 180° plus a radiation angle about an orbital axis of the pair is performed in the respective plane of rotation, in order to obtain a minimum complete data record for the given geometry.

The detectable recording volume may be increased still further if the tomography system is prepared to perform a large volume scan with the first detector and/or with the second detector. With a large volume scan, an angular or orbital rotation of the respective pair of radiation source and detector about 360° about an orbital axis of the pair is performed in order to obtain a minimum complete data record for the given geometry. A center point of a sensor surface of the detector with respect to a central beam of the radiation bundle of the radiation source is displaced by half a detector width in the direction of rotation. As a result, a diameter of the evaluable recording region in the direction of rotation is enlarged approximately by the factor two.

Alternatively or in addition to the large volume scan, an expansion of the field of view in the direction of rotation may also be achieved by reducing the source-to-sensor distance.

Embodiments of the tomography system may differ in that the first data record is two-, three- or four-dimensional. Embodiments of the tomography system may differ in that the second data record is two-, three- or four-dimensional. The comprehensive reconstructed image may likewise be two, three or four-dimensional, where the dimensions are at most as large as the dimension of the one of the two data records that has the smaller dimension.

### BRIEF DESCRIPTION OF THE DRAWINGS

FIG. 1 shows a not to scale schematic perspective representation of one embodiment of a biplanar tomography system having a patient couch and two C-arms;

FIG. 2 shows a not to scale schematic perspective representation, of the patient couch and an exemplary geometry of a recording of a comprehensive data record or reconstruction of a comprehensive volume image that may be performed with the biplanar tomography system; and

FIG. 3 shows a schematic representation of an exemplary course of a method for operating a tomography system.

### DETAILED DESCRIPTION

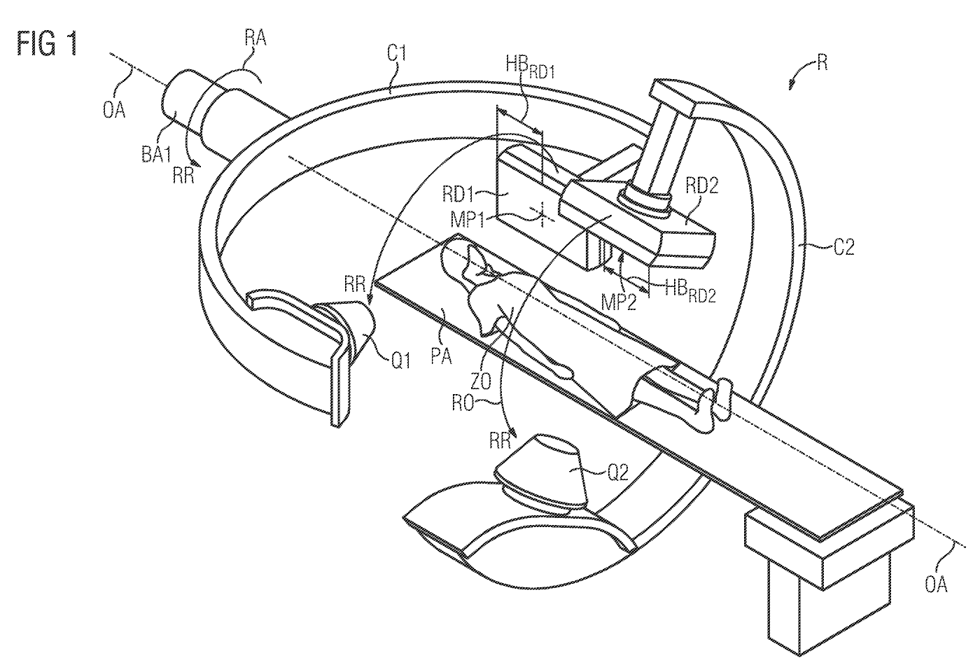

A biplanar tomography system R shown in FIG. 1 has a first C-arm C1, a second C-arm C2, and a patient couch PA. A first radiation source Q1 and a first detector RD1 are fastened to the first C-arm C1. A second radiation source Q2 and a second detector RD2 are fastened to the second C-arm C2. In order to perform a comprehensive scan on an object ZO to be examined, the first C-arm C1 performs an angular rotation RA about an orbital axis OA, while the second C-arm C2 carries out an orbital rotation RO about the same orbital axis OA. With the orbital rotation RO of the second C-arm C2, the plane (e.g., intended plane), in which the second C-arm C2 is disposed, remains unchanged. With the angular rotation RA of the first C-arm C1, the first C-arm C1 rotates about a fastening axis BA1 of the C-arm. A comprehensive scan, in which the first C-arm C1 and the second C-arm C2 are arranged in front of the scan, may also be performed such that both the first C-arm C1 and the second C-arm C2 carry out an angular rotation during the scan or that the first C-arm C1 and the second C-arm C2 are arranged in front of the scan such that both C-arms C1, C2 carry out an orbital rotation during the scan.

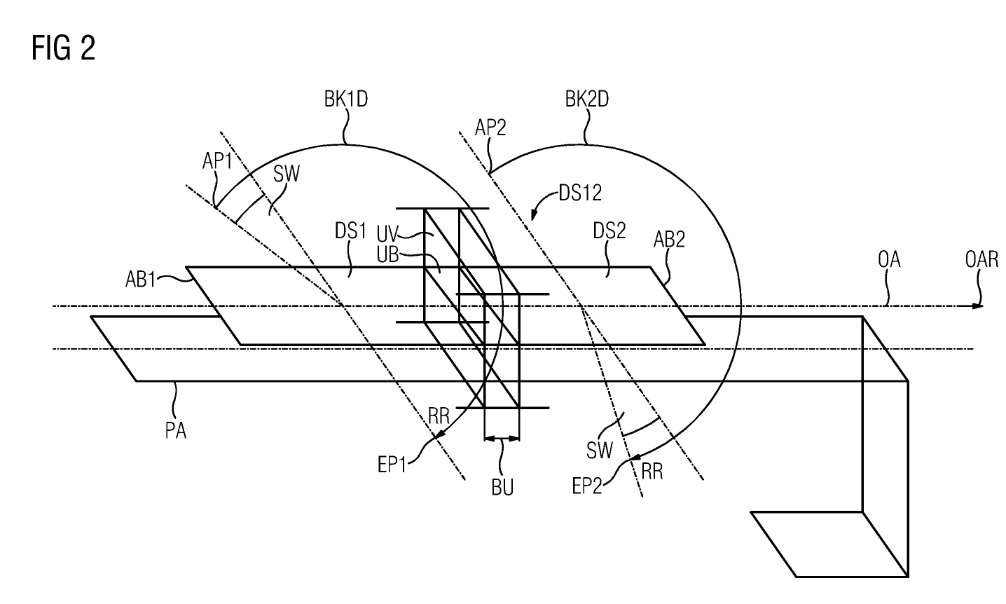

The geometry of a recording of a comprehensive data record or reconstruction of a comprehensive volume image that may be performed with the biplanar tomography system and is shown in FIG. 2 shows a first circular segment-shaped path BK1D with a starting position AP1 and an end position EP1 of a center point MP1 of the first detector RD1. FIG. 2 shows a second circular segment-shaped path BK2D with a starting position AP2 and an end position EP2 of a center point MP2 of the second detector RD2. FIG. 2 also shows a schematic representation of a spatial position of a recording region AB1 of a first data record DS1, which is detected with the first detector RD1 during the scan, and a spatial position of a recording region AB2 of a second data record DS2, which is detected with the second detector RD2 during the scan. Depending on the application, either a scan in portrait mode or a scan in landscape mode may be provided for the body organ or vascular structure to be examined. In portrait mode, the longer principal longitudinal axis of the detector runs in parallel to the orbital axis, while in landscape mode the longer principal longitudinal axis of the detector runs horizontally to the orbital axis.

The two recording regions AB1, AB2 spatially overlap one another in a shared overlapping region UB. If the two data records DS1, DS2 are three or four-dimensional, the shared overlapping region is an overlapping volume UV, which is likewise shown schematically in FIG. 2. Typically, the overlapping is only partial in the direction of the orbital axis, but in all other dimensions, the overlapping is complete. This applies irrespective of whether the data records are two-, three- or four-dimensional. If as complete an overlapping as possible is desired in the remaining dimensions, this may, inter alia, be achieved in that the detectors RD1, RD2 for the synchronous scan are either aligned both in a portrait mode or both in a landscape mode. Applications, in which a comprehensive scan with different modes is provided, exist (e.g., a scan in the landscape mode is combined with a scan in the portrait mode (head in the landscape mode and upper vertebra in the portrait mode; pelvis in the landscape mode and lower vertebra in the portrait mode)).

In one embodiment, a comprehensive two-, three- or four-dimensional data record DS12 is generated from both data records DS1, DS2 before an image reconstruction. The data of the second data record DS2 may be compared with the data of the first data record DS1 in the adjoining region, in the overlapping region UB, or in the overlapping volume UV and may be matched to the data of the first data record DS1 using a spatial and/or temporal mapping, so that a comprehensive data record DS12 is created. The data of the comprehensive data record DS12 in the adjoining region, in the overlapping region UB, or in the overlapping volume UV represents an interference-free transition between the first DS1 and the second data record DS2. Suitable methods for such a manual or automatic adjustment between two data records DS1, DS2 are not described here, since such methods are known to the person skilled in the art under the term “registration”.

A further embodiment of the tomography system provides that the tomography system is configured to generate a first two-, three- or four-dimensional image from the first data record DS1 using a first image reconstruction, a second two-, three- or four-dimensional image from the second data record DS2 using a second image reconstruction, and a comprehensive two-, three- or four-dimensional image from the first and second image. The data of the second reconstructed image may be compared with the data of the first reconstructed image in the adjoining region, in the overlapping region UB, or in the overlapping volume UV and may be matched to the data of the first image using a spatial and/or temporal mapping, so that a comprehensive image is created. The data of the comprehensive image at a joint between the first and the second image or in the overlapping region UB or overlapping volume UV represents an interference-free transition between the first and the second image. Suitable methods for a manual or automatic adjustment between two images, which are known to the person skilled in the art under the term “registration”, may also be used.

In one embodiment, the two planes of rotation RE1, RE2 minus an overlapping width BU are distanced by less than half the width HB_{RD1} of the first detector RD1 plus half the width HB_{RD2} of the second detector RD2. The overlapping width BU amounts, for example, to between 10% and 20% of half the width HB_{RD1} of the first detector RD1 in the orbital axis direction OAR or half the width HB_{RD2} of the second detector RD2 in the orbital axis direction OAR. Using a spatial overlapping of the recording regions AB1, AB2, which may be detected by the detectors RD1, RD2, a spatial gap may also be avoided in the comprehensive overall recording by taking tolerances into account. A structure of the object ZO to be examined may be used to compare the data of the second data record DS2 with the data of the first data record DS1 in the overlapping volume UB or in the overlapping volume UV and using a spatial and/or temporal mapping to match the spatial and/or temporal mapping to the data of the first data record DS1 such that a comprehensive data record DS12 is created. The data of the comprehensive data record DS12 in the overlapping volume UB or overlapping region UV represents an interference-free transition between the first AB1 and the second AB2 recording region.

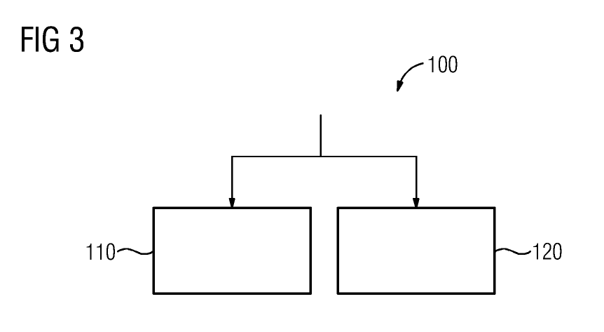

The method 100 shown in FIG. 3 for operating a tomography system R includes, in a first treatment 110, performing a scan. In a first plane of rotation RE1, a first detector RD1 is guided along a first circular segment-shaped path BK1D, while in a second plane of rotation RE2 a second detector RD2 is guided in synchrony along a second circular segment-shaped path BKD2. In a second treatment 120, a first data record DS1 is obtained with the first detector RD1, and a second data record DS2 is obtained with the second detector RD2. The two planes of rotation RE1, RE2 are arranged at a distance from one another.

One or more of the present embodiments relate to a tomography system R having a first radiation source Q1 and a first detector RD1 that is assigned to the first radiation source Q1. The tomography system R also includes a second radiation source Q2 and a second detector RD2 that is assigned to the second radiation source Q2. The tomography system R is prepared to perform a scan. In a first plane of rotation RE1, the first detector RD1 is guided along a first circular segment-shaped path BKD1, while in a second plane of rotation RE2, the second detector RD2 is guided in synchrony along a second circular segment-shaped path BKD2. The tomography system R is prepared to obtain a first data record DS1 with the first detector RD1 and a second data record DS2 with the second detector RD2. The two planes of rotation RE1, RE2 are arranged at a distance from one another.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A tomography system comprising:
a first radiation source and a first detector that is assigned to the first radiation source;
a second radiation source and a second detector that is assigned to the second radiation source,
wherein the tomography system is configured to perform a scan,
wherein in a first plane of rotation, the first detector is guided along a first circular segment-shaped path, while in a second plane of rotation, the second detector is guided in synchrony along a second circular segment-shaped path,
wherein the tomography system is configured to obtain a first data record with the first detector and a second data record with the second detector, and
wherein the first plane of rotation and the second plane of rotation are arranged at a distance from one another.

2. The tomography system of claim 1, wherein the tomography system is configured to generate a comprehensive two-, three- or four-dimensional data record from the first data record and the second data record prior to an image reconstruction.

3. The tomography system of claim 1, wherein the tomography system is configured to generate a first two-, three- or four-dimensional image from the first data record using a first image reconstruction, a second two-, three- or four-dimensional image from the second data record using a second image reconstruction, and a comprehensive two-, three-, or four-dimensional image from the first image and the second image.

4. The tomography system of claim 1, wherein the first plane of rotation and the second plane of rotation minus an overlapping width are distanced by less than half the width of the first detector plus half the width of the second detector.

5. The tomography system of claim 1, wherein the second circular segment-shaped path is arranged concentric to the first circular segment-shaped path, a radius of the first circular segment-shaped path is the same size as a radius of the second circular segment-shaped path, or a combination thereof.

6. The tomography system of claim 1, wherein a starting position of the second circular segment-shaped path is offset in a direction of rotation by a circumferential angle difference with respect to the starting position of the first circular segment-shaped path.

7. The tomography system of claim 1, wherein the tomography system is configured to perform a short scan with the first detector, the second detector, or the first detector and the second detector.

8. The tomography system of claim 1, wherein the tomography system is configured to perform a large volume scan with the first detector, the second detector, or the first detector and the second detector.

9. The tomography system of claim 1, wherein the first data record is two-, three- or four-dimensional, the second data record is two-, three- or four-dimensional, or a combination thereof.

10. A method for operating a tomography system, the method comprising:
performing a scan, the performing of the scan comprising guiding a first detector in a first plane of rotation along a first circular segment-shaped path, and guiding a second detector in a second plane of rotation in synchrony along a second circular segment-shaped path, wherein the first plane of rotation and the second plane of rotation are arranged at a distance from one another; and
obtaining a first data record with the first detector and obtaining a second data record with the second detector.

11. The method of claim 10, further comprising generating, by the tomography system, a comprehensive two-, three- or four-dimensional data record from the first data record and the second data record prior to an image reconstruction.

12. The method of claim 10, further comprising generating, by the tomography system, a first two-, three- or four-dimensional image from the first data record using a first image reconstruction, a second two-, three- or four-dimensional image from the second data record using a second image reconstruction, and a comprehensive two-, three-, or four-dimensional image from the first image and the second image.

13. The method of claim 10, wherein the first plane of rotation and the second plane of rotation minus an overlapping width are distanced by less than half the width of the first detector plus half the width of the second detector.

14. The method of claim 10, wherein the second circular segment-shaped path is arranged concentric to the first circular segment-shaped path, a radius of the first circular segment-shaped path is the same size as a radius of the second circular segment-shaped path, or a combination thereof.

15. The method of claim 10, wherein a starting position of the second circular segment-shaped path is offset in a direction of rotation by a circumferential angle difference with respect to the starting position of the first circular segment-shaped path.

16. The method of claim 10, further comprising performing, by the tomography system, a short scan with the first detector, the second detector, or the first detector and the second detector.

17. The method of claim 10, further comprising performing, by the tomography system, a large volume scan with the first detector, the second detector, or the first detector and the second detector.

18. The method of claim 10, wherein the first data record is two-, three- or four-dimensional, the second data record is two-, three- or four-dimensional, or a combination thereof.
